(19) United States
(12) Patent Application Publication
(10) Pub. No.: US 2007/0041356 A1
(43) Pub. Date: Feb. 22, 2007

(54) Navigating audio books using auditory cues

(76) Inventor: Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/570,238

(22) PCT Filed: Aug. 25, 2004
(86) PCT No.: PCT/IB04/51557

§ 371 Date: Feb. 28, 2006

(30) Foreign Application Priority Data
Sep. 4, 2003 (EP) 03103286.5

(51) Int. Cl. H04L 12/66

(52) U.S. Cl. 370/352

(57) ABSTRACT

The invention provides a record carrier containing an audio file (1). It is an object of the invention the provide an audio file (1) that can be navigated quickly and managed easily. This object is achieved by a record carrier containing an audio file (1) with audio data (2) being segmented into segments (5) to which an address information (6) is assigned indicating a location of a segment (5), pointer data (3) comprising segment indexes (7) representing said segments (5) of said audio data (2) to each of which said address information (6) and an auditory cue (4) is assigned, and said auditory cues (4) being adapted to be sounded during browsing said segment indexes (7).

The invention relates to a record carrier containing an audio file and to an audio file adapted to be navigated by means of a read-out device. The invention also relates to a read-out device for navigating an audio file and to a recording device for recording an audio file. The invention further relates to a method for navigating an audio file and to a method for recording an audio file.

Digital audio books could have been considered a typical niche application, until recently. Currently, audio books are used increasingly. There are certain reasons for the increasing popularity of audio books. Usually, audio books need storage capacities for being stored, which are smaller than the capacities needed for storing video but larger than the capacities needed for storing text. Because of improving compression methods like MPEG-standards, less storage capacity is required making it more convenient to store audio books. Distribution via internet makes it more easy to attain the audio files. Another reason for the increasing popularity may be the proliferation of mobile devices and the increase in storage capacities of these devices. Undoubtedly, reading a book on the move is less convenient than listening to a book. Especially, during driving a car reading a book is impossible, but it is still possible to listen to a book.

According to prior art it is not possible to navigate an audio book. Navigating audio books can be necessary, e.g., when the user wants to find the position within the audio book, where he stopped listening to the last time or the audio book may not be intended to be consumed in sequence, e.g., like a reference book. Audio books were stored analogously on compact cassettes or vinyl records as media. With compact cassettes the counter of a replay device could have been used as a rudimentary navigational tool. With records the physical location of the reading head on the vinyl disc could act as a navigational tool. For audio books on CD the time indication can be used for navigation.

WO 01/44912 A2 describes a hand-held jukebox for playing music titles. The user can store music files in a memory, but the corresponding cues are stored in an extra memory. It is a drawback of the described hand-held jukebox that the music titles are difficult to manage, e.g., download, copy or delete them together with the navigation data.

It is an object of the present invention to provide a record carrier containing audio data that can be navigated quickly and managed easily, and it is an object of the invention to provide an audio file, which can be navigated quickly and managed easily.

It is also an object of the invention to provide a read-out device for navigating said audio file and a recording device for recording said audio file.

It is further an object of the invention to provide a method for navigating and a method for recording said audio file.

The first object is achieved according to the invention by a record carrier containing an audio file adapted to be navigated by means of a read-out device, comprising audio data being segmented into segments to which an address information is assigned indicating a location of a segment, pointer data comprising segment indexes representing said segments of said audio data to each of which said address information and an auditory cue is assigned, and said auditory cues being adapted to be sounded during browsing said segment indexes.

According to the present invention the navigation data, i.e., the pointer data and the auditory cues are stored together with the audio data within one file. This makes it easy to manage, e.g., download, copy or delete the audio data together with the navigation data.

The audio segments are assigned to address information. The address information refers to the beginning of each segment, preferably. The address information can be time code data. If the audio data are stored in a packet stream it is also possible to choose a packet number as the address information on the level of the stream or a byte offset on the level of the file. In case the content is tied to the medium it is also possible to choose a sector number with byte offset in the sector. Preferably, time code data are chosen, because any address information has to be translated into time code data at some stage, especially in case of MPEG. The presentation of the audio is based on time codes. It is native to the application. Choosing time code data provides more control over the audio. Independent of the choice of the address information, in any case, some part of the stream has to be interpreted to find the location. To minimize the interpretation to one packet header the reference should be aligned with the packets. It is easy for a creator of a file to align time code data with packets.

In a preferred embodiment of the invention the pointer data and auditory cues are stored at the end of said auditory file. Advantageously, the navigation data are not embedded in the audio data, thus, they do not jeopardise seamless playback of the audio. Storing cue data together with the pointer data ensures quick navigation, because the cues do not have to be picked up from the audio data.

The invention can be applied to audio books as well as music, e.g., audio symphonies, scenes in a musical, parts of a symphony, etc.

The object is achieved by an audio file, as claimed in claim 5. The audio file can be stored on different media. A basic idea of the invention is to store audio data, pointer data and auditory cues together in one file. This is independent of the recording media, e.g., a record carrier. It is also possible that the audio file is stored on a hard disc drive of a PC or it can be just binary information transferred via internet.

The object is also achieved by a read-out device for navigating said audio file comprising a browser for browsing said segments, means for sounding said auditory cue assigned to the segment index being encountered during browsing, means for selecting a segment index representing a segment being selected to be read, and means for reading the selected segment starting from the location indicated by the address information assigned to the selected segment index.

An advantage of a read-out device according to the present invention is the fact that off-line navigation is possible. That is, the cues appear not while browsing the audio data, but only the segment indexes are browsed. The cues are preferably stored at the end of the audio file meaning that the system is backward compatible and the cues do not interrupt the seamless playback of successive audio segments. Preferably, the segment indexes are stored in a cache, where the segment indexes are browsed off-line. Collecting all segment indexes and storing the segment indexes together with the cues enables quick retrieval and hence navigation with minimal buffered capacity. The cues do not have to be picked from the stream, which would require additional processing and loss of interactivity and require extra time.

In a preferred embodiment of the invention the read-out device contains a volume knob having a circumference, which is in sections mapped to the assigned section indexes, and the volume knob is adapted to browse the segment indexes. An advantage of this embodiment of the read-out device is the reuse of existing user interface components, namely the volume knob. In a different embodiment it is also possible to use the fast forward and reverse button to browse to a following or previous section indexes by pressing the corresponding button. It is also possible to use the next/previous button in the described way. Another possibility is to use a physical slider or a virtual slider on a touch screen for controlling browsing.

The object of the invention is also achieved by a method for navigating an audio file as claimed in claim 11 and by a method for recording an audio file as claimed in claim 12.

The invention will now be described by way of an example with reference to the drawings, in which:

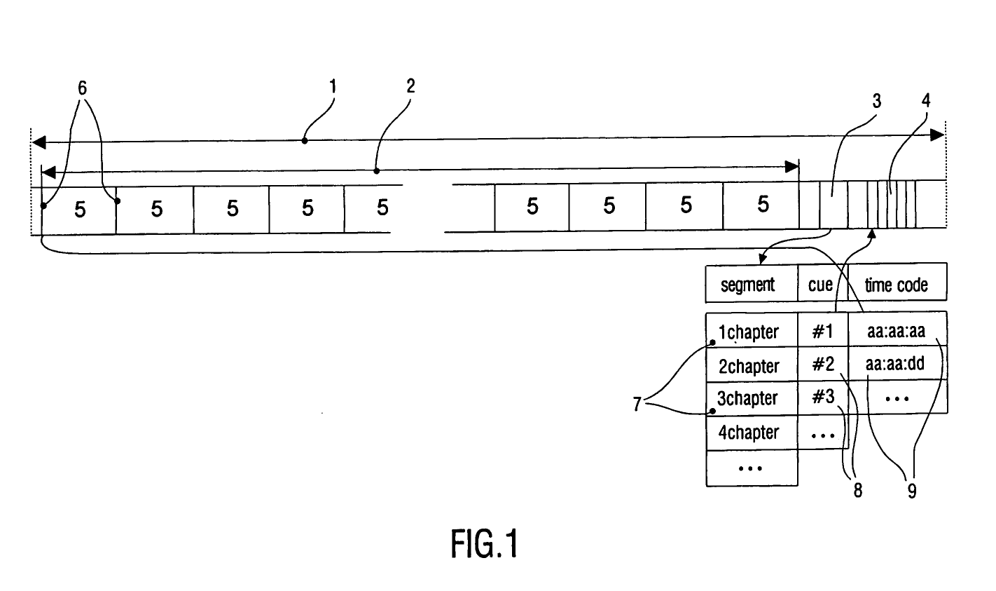

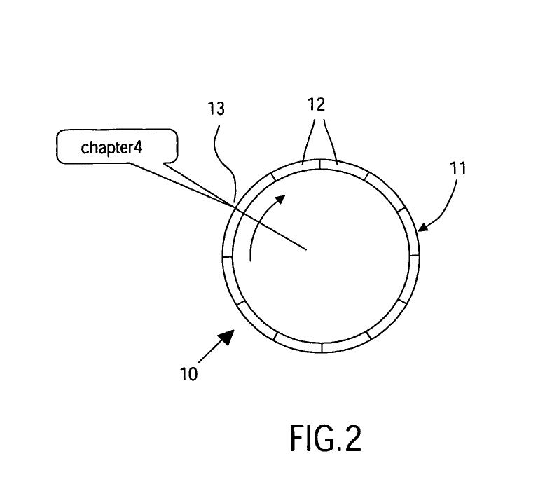

FIG. 1 shows the structure of an audio file according to the present invention, FIG. 2 shows a volume knob of a read-out device with a circumference, which is in sections mapped to assigned section indexes.

FIG. 1 shows the structure of an audio file 1 according to the invention. The audio file 1 contains audio book data 2 stored at the beginning of the audio file 1, pointer data 3, and cue data 4. The audio file can be stored as a packet stream, which is MPEG-coded. But also other codings in an MPEG transport stream are possible. The pointer data 3 and the cue data 4 are located at the end of the audio file 1. In this example the audio data 2 are audio data of an audio book. As shown in FIG. 1 the audio book contains a number of chapters 5. Time code data 6 are assigned to each chapter 5. The time code data 6 are stored in a location at the beginning of each chapter 5.

Adjacent to the audio book 2 pointer data 3 are stored in the audio file 1. The pointer data 3 contain chapter indexes 7. Each chapter index 7 is assigned to a cue address 8 and to a time code address 9. The pointer data 3 and cue data 4 are the navigation data of the audio file 1.

The audio file 1 is stored on a DVD-disc or Portable Blue disc, which can be read out by a read-out device according to the present invention. Before navigating the audio book 2 the pointer data 3 are cached in a memory of the read-out device. The read-out device comprises a browser adapted to browse the cached chapter indexes 7 of the pointer data 3. Each time the browser passes a tag to a new chapter index 7 the read-out device sounds a corresponding cue 4 indicated by the cue address 9 assigned to the chapter index 3. In this way the whole audio book can be browsed off-line.

In this embodiment of the invention the read-out device provides a volume knob 10 with circumference 11, which is in sections 12 mapped to assigned section indexes 7. Turning the volume knob 10 as indicated in FIG. 2 by the arrow each time a chapter tag 13 is passed the corresponding cue 4 is sounded. If the chapter tag for chapter 4 is passed, “chapter 4” is sounded in words.

By pressing the volume knob 10 the currently sounded chapter name can be selected. A different solution would be a “time delay” selection, i.e., if the user stops turning the knob, the current position is selected after a set delay of time. It is also possible to provide a separate knob for selection. The read-out device contains read-out means for reading out the audio book 2. Selecting a certain chapter 5 the read-out means will jump to the time code data 6 addressed by the time code address 9 assigned to the chapter index 7 being selected. The pointer data 3 and the cue data 4 are embedded in the audio stream at the end of the audio file 1 maintaining backward compatibility and seamless playback.

In this embodiment of the invention all information needed for navigating the audio book 2 are stored together with the audio book 2 in one audio file 1. This makes it easy to download, copy and delete the audio book 2 and the navigation data, this is, the pointer data 3 and cue data 4.

For sounding the cues 4 speakers can be provided. The cues 4 can be sounded as beeps, clicks or the like. In this example the cues are sounded by sounding the name “chapter” and the corresponding number. The stored cue can be a piece of audio. If audio cues are not provided, clicks, beeps etc. can be used. The cue may also be a selection number, selecting a cue from a bank of cues. You can imagine a trade in cue-banks similar to the ring-tone trade.

The invention provides a record carrier containing an audio file 1. It is an object of the invention the provide an audio file 1 that can be navigated quickly and managed easily. This object is achieved by a record carrier containing an audio file including pointer data 3 and cue data 4. The pointer data 3 contain segment indexes 7 that can be browsed off-line.

1. Record carrier containing an audio file (1) adapted to be navigated by means of a read-out device, comprising:
audio data (2) being segmented into segments (5) to which an address information (6) is assigned indicating a location of a segment (5),
pointer data (3) comprising segment indexes (7) representing said segments (5) of said audio data (2) to each of which said address information (6) and an auditory cue (4) is assigned, and
said auditory cues (4) being adapted to be sounded during browsing said segment indexes (7).

2. Record carrier as claimed in claim 1, characterized in that said address information (6) is a time code, a packet number or a physical address.

3. Record carrier as claimed in claim 1, characterized in that said segments (5) are chapters of an audio book, scenes in a musical or parts of a symphony.

4. Record carrier as claimed in claim 1, characterized in that said pointer data (3) and said auditory cues (4) are stored at the end of said audio file (1).

5. Audio file adapted to be navigated by means of a read-out device, comprising:
audio data (2) being segmented into segments (5) to which an address information (6) is assigned indicating a location of a segment (5),
pointer data (3) comprising segment indexes (7) representing said segments (5) of said audio data (2) to each of which said address information (6) and an auditory cue (4) is assigned, and
said auditory cues (4) being adapted to be sounded during browsing said segment indexes (7).

6. Read-out device for navigating an audio file (1), wherein said audio file (1) contains audio data (2) being segmented into segments (5) to which an address information (6) is assigned indicating a location of a segment (5), pointer data (3) comprising segment indexes (7) representing said segments (5) of said audio data (2) to each of which said address information (6) and an auditory cue (4) is assigned, and said auditory cues (4) being adapted to be sounded during browsing said segment indexes (7), comprising:
a browser for browsing said segment indexes (7),
means for sounding said auditory cue (4) assigned to the segment index being encountered during browsing,
means for selecting a segment index (7) representing a segment (5) being selected to be read, and
means for reading the selected segment (5) starting from the location indicated by the address information (6) assigned to the selected segment index (7).

7. Read-out device as claimed in claim 6, characterized by a cache for storing the segment indexes (7).

8. Read-out device as claimed in claim 6, characterized by a volume knob (10) being adapted to browse the segment index (7) with a circumference (11), which is in sections (12) mapped to assigned section indexes (7).

9. Read-out device as claimed in claim 6, characterized by a fast forward button and reverse button being adapted to browse to a following or previous section index (7) by pressing the corresponding button.

10. Recording device for recording an audio file (1), wherein said audio file (1) contains audio data (2) being segmented into segments (5) to which an address information (6) is assigned indicating a location of a segment (5), pointer data (3) comprising segment indexes (7) representing said segments (5) of said audio data (2) to each of which said address information (6) and an auditory cue (4) is assigned, and said auditory cues (4) being adapted to be sounded during browsing said segment indexes (7), comprising:
means for locating address data (6) at each segment (5),
means for recording said pointer data (3), and
means for recording said auditory cues (4).

11. Method for navigating an audio file (1) by means of a read-out device, wherein said audio file (1) contains audio data (2) being segmented into segments (5) to which an address information (6) is assigned indicating a location of a segment (5), pointer data (3) comprising segment indexes (7) representing said segments (5) of said audio data (2) to each of which said address information (6) and an auditory cue (4) is assigned, and said auditory cues (4) being adapted to be sounded during browsing said segment indexes (7), comprising the steps of:
browsing said segment indexes (7),
sounding an auditory cue (4) assigned to the segment index (7) being encountered during browsing,
selecting a segment index (7) representing a segment (5) selected to be read, and
reading the selected segment (5) starting from the location indicated by the address information (6) assigned to the segment index (7).

12. Method for recording an audio file (1), wherein said audio file (I) contains audio data (2) being segmented into segments (5) to which an address information (6) is assigned indicating a location of a segment (5), pointer data (3) comprising segment indexes (7) representing said segments (5) of said audio data (2) to each of which said address information (6) and an auditory cue (4) is assigned, and said auditory cues (4) being adapted to be sounded during browsing said segment indexes (7), comprising the steps of:
locating address data at each segment (5),
recording said pointer data (3), and
recording said auditory cues (4).
